(19) United States
(12) Patent Application Publication
(10) Pub. No.: US 2009/0144830 A1
(43) Pub. Date: Jun. 4, 2009

(54) SECURE DIGITAL CONTENT DELIVERY SYSTEM AND METHOD

(75) Inventors: Alan D. Davis, Leander, TX (US); Stephen Robert DeVoy, Round Rock, TX (US); George David Nincehelser, Round Rock, TX (US)

Correspondence Address: HULSEY IP INTELLECTUAL PROPERTY LAWYERS, P.C., 919 Congress Avenue, Suite 919, AUSTIN, TX, 78701, US

(73) Assignee: IGNITE LEARNING, INC., Austin, TX (US)

(21) Appl. No.: 12/176,991

(22) Filed: Jul. 21, 2008

Related U.S. Application Data
(63) Continuation of application No. 11/947,700, filed on Nov. 29, 2007, now abandoned.

(51) Int. Cl. G06F 21/00

(52) U.S. Cl. 726/26

(57) ABSTRACT

A secure digital content delivery system comprising a storage medium 302 with secure digital content along with an embedded computing device 304 for making the secure digital content available via a computing device interface 306.

### CROSS REFERENCE TO RELATED APPLICATION

This application is a continuation of and claims priority to U.S. patent application Ser. No. 11/947,700 entitled, “SECURE DIGITAL CONTENT DELIVERY SYSTEM AND METHOD” filed on Nov. 29, 2007, and is incorporated herein by reference in its entirety

### FIELD

The present invention relates generally to content delivery methods and systems, and more particularly to a secure digital content delivery system and method.

### DESCRIPTION OF THE RELATED ART

A significant problem exists with intellectual property protection of electronic content. Software piracy and other forms of intellectual property theft are common.

Software piracy is the unauthorized duplication of computer software. Although most computer users today are aware that unauthorized use and duplication of software is illegal, many show a general disregard for the importance of treating software as valuable intellectual property.

Software must be protected from unauthorized use in order to ensure new and existing revenue streams. Software piracy, by decreasing revenue streams, results in less research and development investments.

A standard storage medium, such as a DVD, CD, or floppy disk, etc. does not offer a high level of protection against content piracy.

A need exists for a secure content delivery system and method.

### SUMMARY

In satisfying the above-stated needs, the present disclosure provides a secure digital content delivery system and method.

According to one aspect of the disclosed subject matter, there is provided a secure digital content delivery system comprising a storage medium with secure digital content along with an embedded computing device for making the secure digital content available via a computing device interface.

According to another aspect of the disclosed subject matter, there is provided a method for secure digital content delivery.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the accompanying claims.

### BRIEF DESCRIPTIONS OF THE DRAWINGS

The features, nature, and advantages of the disclosed subject matter will become more apparent from the detailed description set forth below when taken in conjunction with the drawings in which like reference characters identify correspondingly throughout and wherein:

FIG. 1 shows a view of an embodiment of a portable unit;

FIG. 2 shows a process flow for determining if HASP driver was previously installed;

FIG. 3 shows a process flow for determining if HASP driver was previously installed;

FIG. 4 shows a process flow of waiting for and processing responses to the user choices;

FIG. 5 shows a process flow in the event that the HASP driver was not previously installed;

FIG. 6 shows a process flow for a user selection of “Run”;

FIG. 7 shows a process flow for a user selection of “Uninstall”;

FIG. 8 shows a view of an embodiment of a user interface of the HASPEditor program;

FIG. 9 shows a view of an embodiment of a user interface of the HASPEditor program;

FIG. 10 shows a view of an embodiment of a user interface of the HASPEditor program;

FIG. 11 shows a view of an embodiment of a user interface of the HASPEditor program;

FIG. 12 shows a view of the processes and components accessed by the licensing process;

FIG. 13 shows a view of the processes and components accessed by the end user;

FIG. 14 shows an overlapping view of the processes and components illustrated in FIGS. 12 and 13; and

FIG. 15 provides an overview of the architecture and update processes.

### DETAILED DESCRIPTION OF THE SPECIFIC EMBODIMENTS

A standard storage medium, such as a DVD, CD, or floppy disk, etc. does not offer a high level of protection against content piracy. The disclosed subject matter provides for the secure storage of the digital content on a storage medium included in a portable unit. The storage medium is connected to a computing device which makes the secure digital content available via a computing device interface.

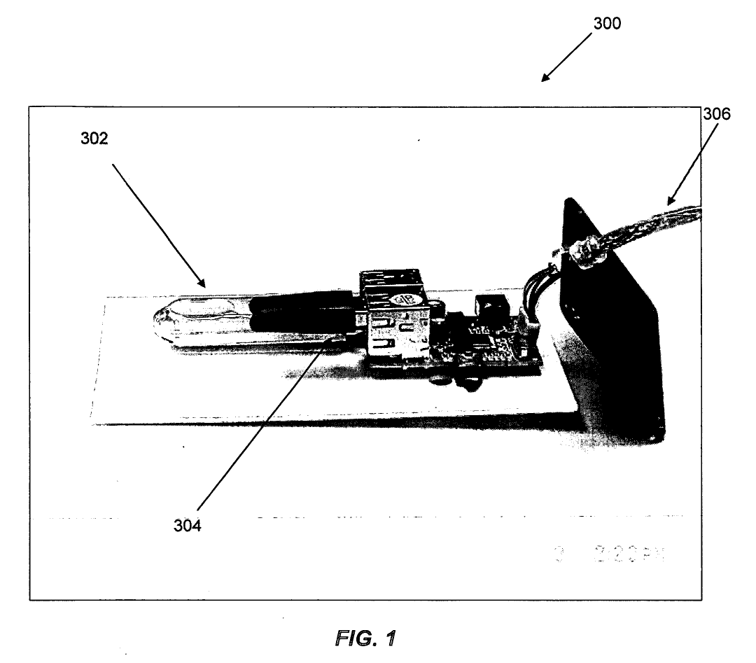

In one embodiment, illustrated in FIG. 1, the portable unit 300 includes a flash memory storage medium 302 with encrypted secure digital content, the computing device 304 is a 128 bit AES encryption chip from Aladdin, Inc. of Israel, and the computing device interface 306 is a USB interface.

The portable unit 300 can be plugged into the USB interface on any computer. The content goes along with the portable unit 300. As long as the unit 300 is connected to the computer, the user has access to the secure content. The decryption of the secure content and delivery to the computer via the computing device 304 is transparent to the user.

The disclosed subject matter is unique with regard to several aspects of its design and use. The portable unit 300 is both a hardware and software device. The hardware can be connected to a Windows PC by plugging its USB connector 306 into a PC with Windows XP or Windows Vista installed. Upon connection, software contained within the unit 300 is either offered for single click execution or executes automatically, depending upon the system settings of the PC to which it is connected, making the portable unit 300 easy to use, even for those with limited computer skills.

In an alternative embodiment, the portable unit 300 may be embedded in another device. The portable unit 300 may be embedded in a peripheral device such as an interactive whiteboard, printer audience response system, among others. The portable unit 300 may also be embedded directly within a computer chassis. Thus, the portable unit 300 may provide secure content to peripherals via the USB connector 306, enhancing the functionality of such peripheral devices.

The software is comprised of an application designed and developed by Applicants and various drivers/support applications provided by Aladdin, Inc., the maker of the computing device 304. The application developed by Applicants is responsible for launching the secure digital content application on the Windows PC.

For reasons of digital rights protection, the content application and its associated media are encrypted on the storage medium 302. Decryption is provided by Aladdin's HASP product. In order to use Aladdin's HASP decryption functionality, a driver which identifies a subcomponent of the portable unit 300's hardware must be installed on the user's Windows PC.

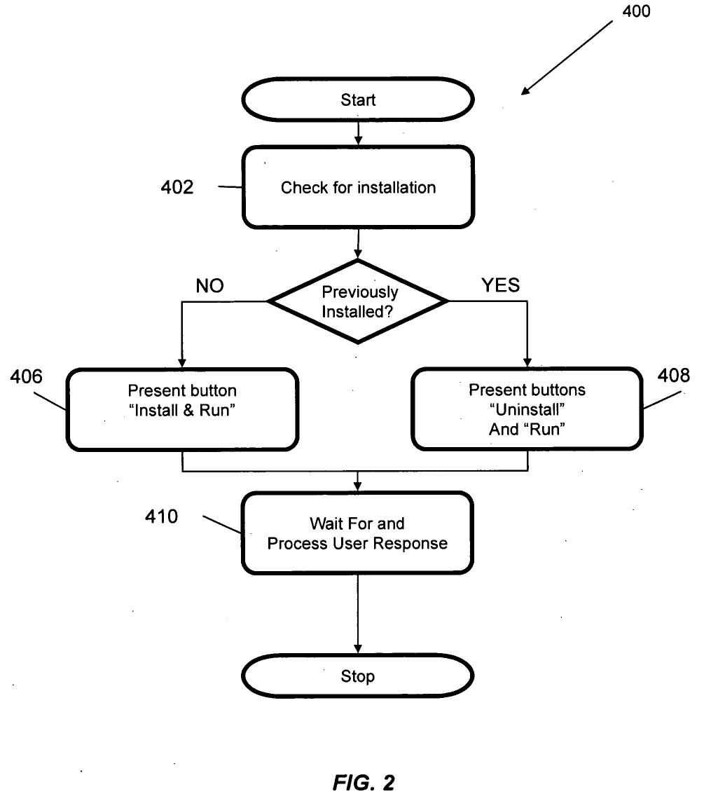

The process flow 400 shown in FIG. 2 begins with the launch software inspecting the connected Windows PC to determine whether or not it has previously installed this HASP driver. In step 402, the launch software determines if Aladdin's HASP driver is already installed on the machine. If Aladdin's HASP driver has not previously been installed on the machine, the launch software offers the option 406 to automatically install this driver and run the secure digital content application. If the HASP driver has previously been installed, the launch software offers the options 408 to launch the secure digital content application or to uninstall the driver.

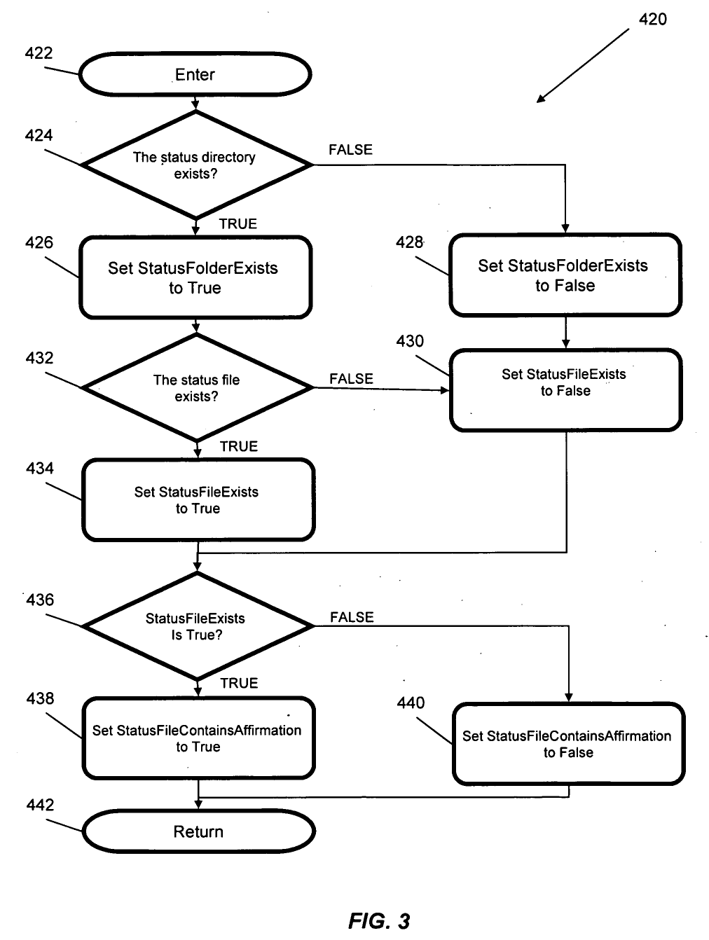

If the user chooses the option 406 to install and run, the HASP driver is installed using Aladdin's program haspdinst.exe. The launch software creates a special directory on the connected Windows PC to store a file specifying the installation status, waits for haspdinst.exe to finish, and then launches the secure digital content application. If the user chooses only to run in option 408, secure digital content is launched. If the user chooses to uninstall in option 408, Aladdin's program haspdinst.exe is run with an option indicating that the driver should be uninstalled. Step 410 shows that the launch software waits for and processes the user response (see FIG. 3 below).

The following FIGUREs outline pseudo-code of the steps described in FIG. 2.

FIG. 3 outlines pseudo-code process flow 420 of checking the Windows PC to determine whether or not it has previously installed the HASP driver, corresponding to step 402 of FIG. 2. Beginning at 422, the program checks to see if the status directory exists 424. If it does (true), the variable StatusFolderExists is set to true 426; if not (false), then StatusFolderExists is set to false 428 and StatusFileExists is set to false 430. The program next checks to see if the status file exists 432. If it does (true), the variable StatusFileExists is set to true 434; if not (false), StatusFileExists is set to false 430. The program again checks to see is the status file exists 436. If it does (true), the variable StatusFileContainsAffirmation is set to true 438; if not (false), StatusFileContainsAffirmation is set to false 440, then a return 442.

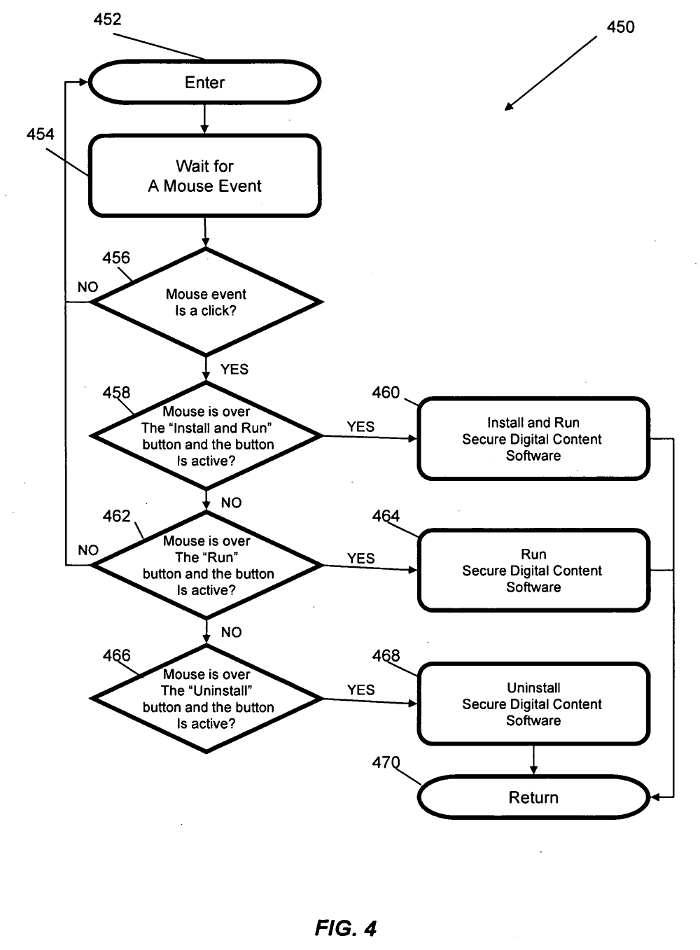

FIG. 4 outlines pseudo-code process flow 450 of waiting for and processing responses to the user choices, corresponding to step 410 of FIG. 2. Beginning at 452, the program waits for a mouse event 454. If mouse event is a click 456, the program determines if the mouse is over the “Install and Run” button, and the button is active 458; if mouse event is not a click, then the program waits for a mouse event 454. If the mouse is over the “Install and Run” button, and the button is active 458, then the program proceeds to install and run the secure digital content software 460. If the mouse is over the “Run” button, and the button is active 462, then the program runs the secure digital content software 464. If the mouse is over the “Uninstall” button, and the button is active 466, then the program uninstalls the secure digital content software 468, then a return 470.

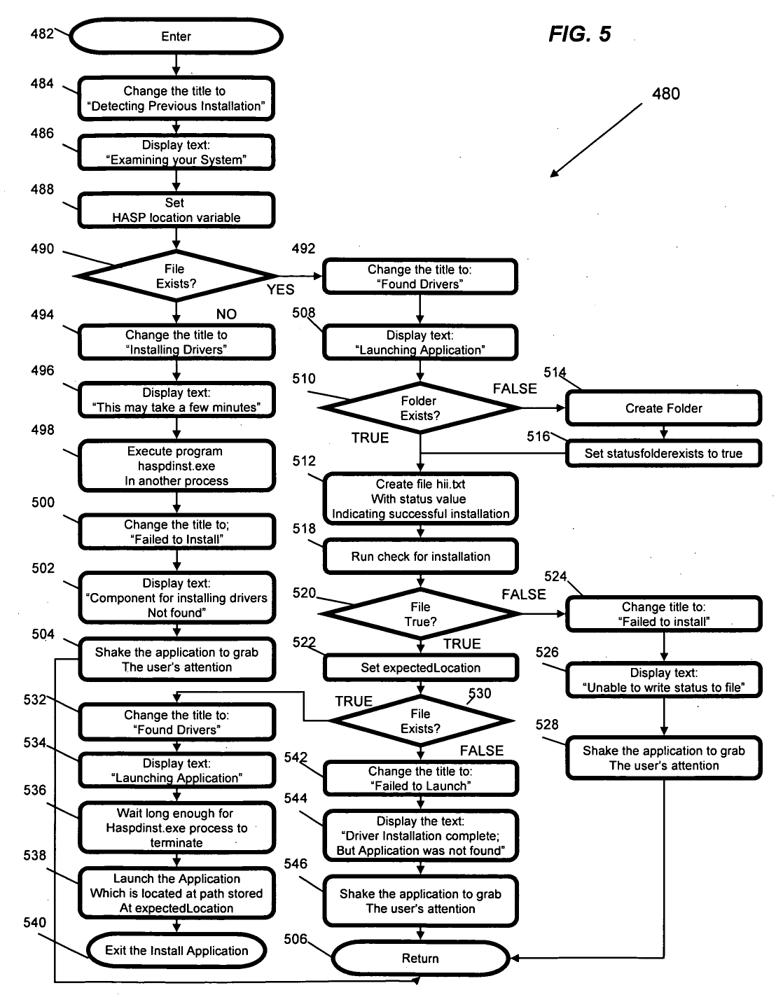

FIG. 5 outlines pseudo-code process flow 480 of the installation process, in the event that the portable unit 300 has not previously installed Aladdin's HASP driver on the machine. Beginning at 482, the program displays a title of “Detecting Previous Installation” 484 displaying text of “Examining your system” 486. The program then sets location variable expectedLocationOfHASPInstallApp to “\1\2\3\4\system\haspdinst.exe” 488. Next it determines if the file expectedLocationOfHASP exists 490. If it does (true), the title is changed to “Found Drivers . . . ” 492; if not (false), the title is changed to “Installing Drivers . . . ” 494, then text of “This may take a few minutes” 496. The haspdinst.exe program is then executed in another process 498, with title changed to “Failed to Install” 500, displaying text of “Component for installing drivers not found” 502, and the program shaking the application to grab the user's attention 504, then a return 506. Referring back to step 492, where the drivers are found, the text of “Launching Application” is displayed 508. The program next determines if the status folder exists 510 by checking the variable statusFolderExists. If it does (true), the program creates the file “C:\_ignite\hii.txt” 512, saving into it a status value indicating a successful installation; if it does not (false), the program creates the folder “C:\_ignite” 514, then statusFolderExists is set to true 516, and the program then creates the file “C:\_ignite\hii.txt” 512. The program then runs a check for installation 518, by determining if statusFileContainsAffirmation is true 520. If true, the program sets the variable expectedLocation to “\Application.exe” 522; if false, the title is changed to “Failed to Install” 524, displaying text of “Unable to write status to file” 526 and shaking the application to grab the user's attention 528, with a return 506. The program next determines if the file located at expectedLocation exists 530. If it does (true), then the title is changed to “Found Drivers” 532, displaying text of “Launching the Application. This makes take several seconds” 534. The program waits long enough for the haspdinst.exe process to terminate 536, then the secure digital content application is launched 538, which is located at path stored in expectedLocation, and the Install application exits 540. If expectedLocation does not exist (false), then the title is changed to “Failed to Launch” 542, displaying text of “Installation of drivers is complete. However, the application was not found.” 544, then shaking the application to grab the user's attention 546, with a return 506.

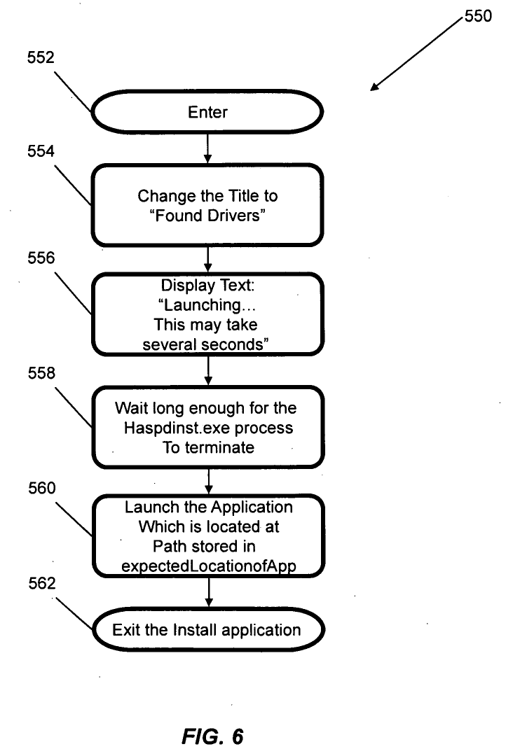

FIG. 6 outlines pseudo-code process flow 550 for a user selection of “Run” (refer to step 462 in FIG. 4). Beginning at 552, the program changes the title to “Found Drivers” 554 and displays text “Launching . . . this make take several seconds” 556. The program waits long enough for the haspdinst.exe process to terminate 558, then launches the secure digital content application which is located at expectedLocationofApp 560. The install application then exits 562.

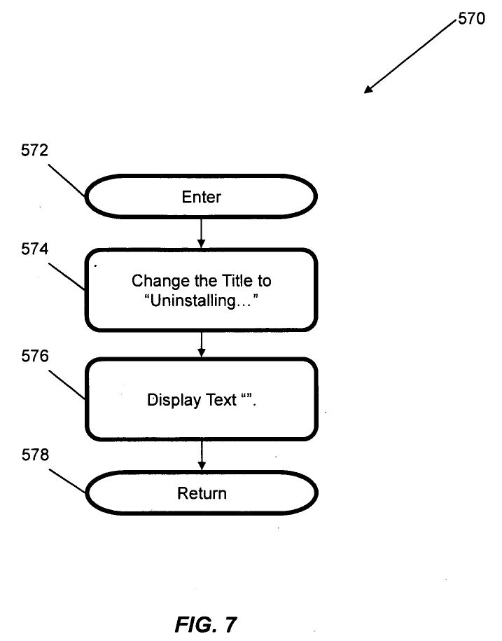

FIG. 7 outlines pseudo-code process flow 570 for a user selection of “Uninstall” (refer to step 466 in FIG. 4). Beginning at 572, the program changes the title to “Uninstalling . . . ” 574 and displays text 576 and returns 578.

Applicant has developed a license enforcement system for the content on the portable unit. This mechanism is the integration of several technologies, both in hardware and software. This system allows the specification and enforcement of four license types: permanent; use count; time limit; and date limit. A permanent license allows the user to use the secure digital content without restriction. A use count license incorporates a counter that permits the secure digital content to be used a specified number of times. Once that specified number of uses is exceeded, the portable unit 300 no longer provides access to the secure digital content. A time limit license monitors the date each time the secure digital content application is executed. If the interval of time between its first use and its current use exceeds the time interval specified for the specific portable unit 300 instance, the portable unit 300 no longer provides access to the secure digital content. A date limit license monitors the date each time the secure digital content application within the portable unit 300 is executed. If the current date exceeds the maximum date specified by the secure digital content provider for the specific portable unit 300 instance, the portable unit 300 no longer provides access to the secure digital content.

With the exception of the permanent license, all other licenses provide two warnings before ceasing to function. Using the HASPEditor program, a representative of the secure digital content provider sets the criteria for the first and second warnings. A view 580 of an example of the user interface of the HASPEditor program is shown in FIG. 8. The user interface is divided into four parts, one part for each license type. Additionally, the interface has two buttons: a “Read Key” button and a “Write Key” button.

If a portable unit 300 is attached to the USB port of a computer running the HASPEditor program, the “Read Key” button examines the memory of the key and automatically selects the radio button corresponding to the license type already encoded on the portable unit 300. If the portable unit 300 has not been previously licensed, none of the radio buttons will show themselves as selected immediately after clicking the “Read Key” button.

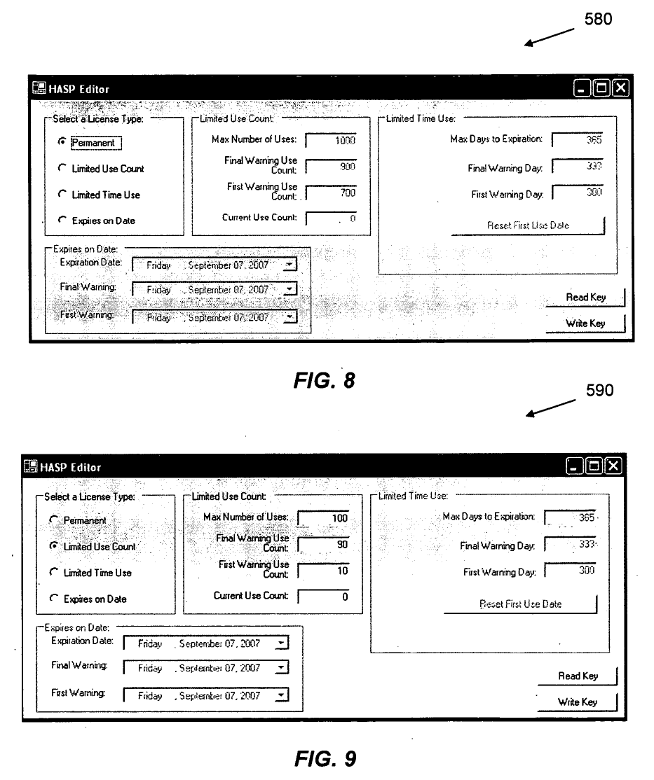

At any time, the user may select one of the radio buttons listed within the group entitled “Select a License Type”. Upon selecting a radio button, the appropriate license group within the dialog box becomes active. If the license type is “Permanent”, no further data is required and only the “Select a License Type” group box, and its subcomponents, are activated (see above). If the license type is “Limited Use Count”, the group box entitled “Limited Use Count” and its subcomponents is activated. All other license type boxes are deactivated as shown in FIG. 8. In the view 590 shown in FIG. 9, the license limits use of the portable unit 300 currently attached to the USB port to 100 uses. Its current use count is set to 0. A first warning about future inaction will be given upon the tenth use. The second (final warning) will be given after 90 uses. The unit 300 will cease functioning after 100 uses.

Upon specifying the above license, the representative of the secure digital content provider, using the HASP Editor, would press the write key. Data representing the above constraints would be encoded in the HASP key within the portable unit 300.

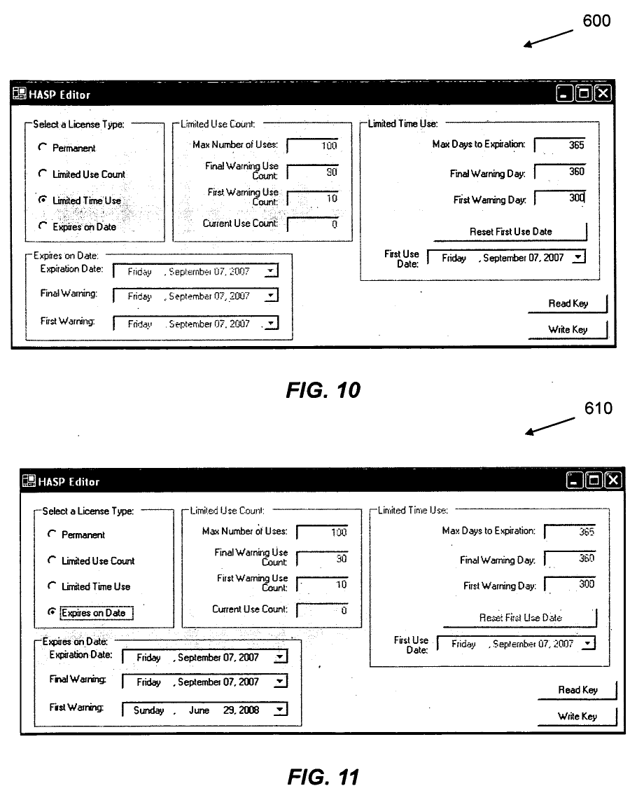

Next we consider the limited time use license as shown in view 600 of FIG. 10. In the above example, the user has specified a limited time use license. Initially, the first use date may be undefined or may be the date the HASP Editor is invoked to edit the HASP key within the portable unit 300. If an undefined first use date is desired, the user should click the “Reset First Use Date” button. If the current date is desired as the first use date, that date should be specified in the “First Use Date” calendar box. The user may enter a maximum number of days use time interval in the top text box within the limited time use group box. This is the number of days until expiration after the first use date. If the user does not specify a first use date, the first use date is the date the secure digital content application is first executed by the customer. The first warning date text box specifies the number of days after the first use date at which a warning of future expiration will be presented to the user. The second warning date (last warning) text box specifies the number of days after the first use date at which a warning of future expiration will be presented to the user.

Next we consider date limit license as shown in view 610 of FIG. 11. The date limit license is a license that expires on a specific date. It contains two warning dates, each specified as shown. Once the representative of the secure digital content provider, using the HASP Editor, has specified the license, she presses the “Write Key” button to encode the licensing data onto the portable unit 300.

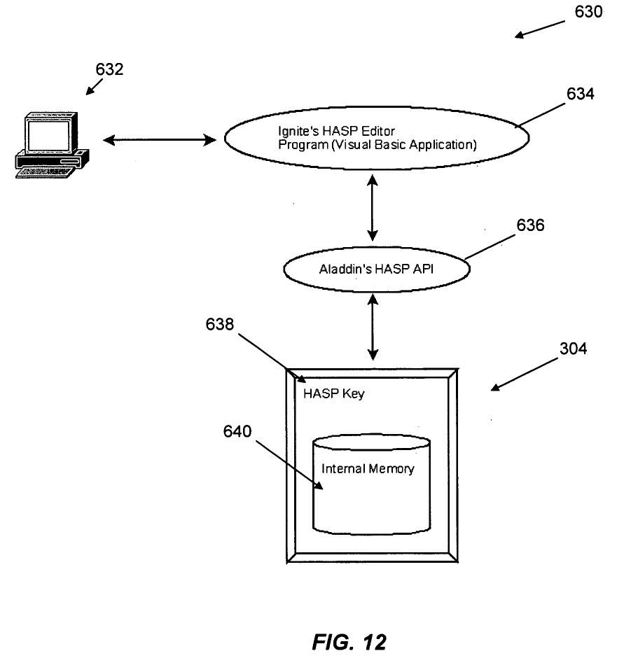

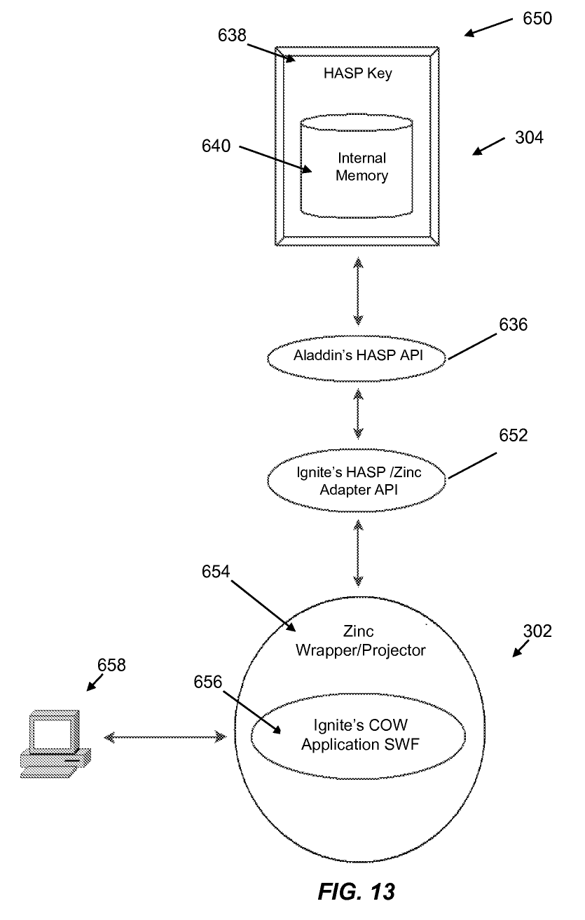

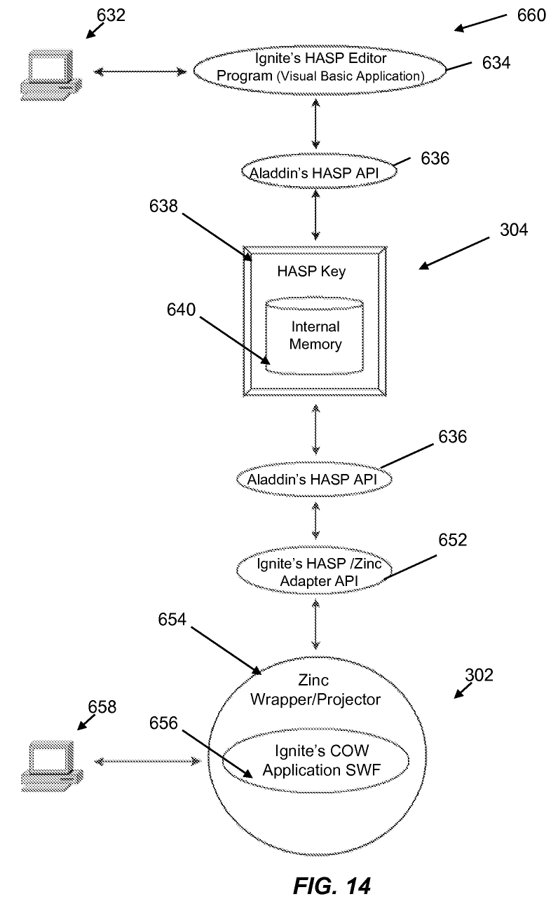

The following FIGUREs illustrate interaction with the portable unit from the perspective of the secure digital content provider representative using the HASP Editor software as well as the end user accessing the secure content on the unit with license information encoded using that HASP Editor software. Specifically, FIG. 12 shows a view 630 of the processes/components accessed by the licensing process. FIG. 13 shows a view 640 of the processes/components accessed by the end user. Finally, FIG. 14 shows an overlapping view 660 of the processes/components illustrated in FIGS. 12 and 13.

Referring to view 630 in FIG. 12, a secure digital content provider representative uses a computer 632 to interact with Applicants' HASP Editor program 634 (in one embodiment, a Visual Basic application) which interfaces with Aladdin, Inc.'s HASP API 636 (a DLL from Aladdin, Inc.), allowing for communication with computing device 304 as described above. The computing device 304 contains a HASP key 638 and internal memory 640.

Referring to view 650 in FIG. 13, a second component is a DLL 652 which serves as a bridge between the HASP API 636 and Zinc 654, a product used to convert the Adobe Flash application 656 stored on flash memory storage medium 302 (described above) to a Windows Application for use on an end user's computer 658. The HASP/Zinc bridge 652 is a DLL developed by Applicants using the Visual C++ language. A third component is a licensing component within the Adobe Flash application 656, including a set of Adobe Flash classes written in a combination of ActionScript and Zinc's MDM Script.

Aladdin, Inc.'S DLL 636 requires passing arguments by reference. Zinc's API 654 cannot pass arguments to a DLL by reference. The HASP/Zinc bridge 652 passes all arguments by value and maintains, within the DLL, all handles required by the HASP API 636, managing these handles on behalf of Zinc 654. Using this technique, secure digital content application software, written in ActionScript/Adobe Flash stored on flash memory storage medium 302, can communicate with the HASP key 638 using Zinc 654 to communicate with the HASP/Zinc bridge 652 and then using the bridge 652 to communicate with the HASP device 304.

The licensing component reads the data encoded upon the HASP device 304 by the HASP Editor 634 and then either launches, launches and warns, or refuses to launch the secure digital content application based upon this data.

The disclosed subject matter can be used to effectively manage licenses for any type of electronic content. In the embodiment described above, the secure digital content application software is written in ActionScript/Adobe Flash and stored on a flash memory storage medium. The above technique may be used to allow communication from secure digital content application software written in other programming languages with Aladdin, Inc.'S HASP API 636. In this way, secure digital content can easily be stored on a readily available and inexpensive flash memory storage medium 302 with effective license management.

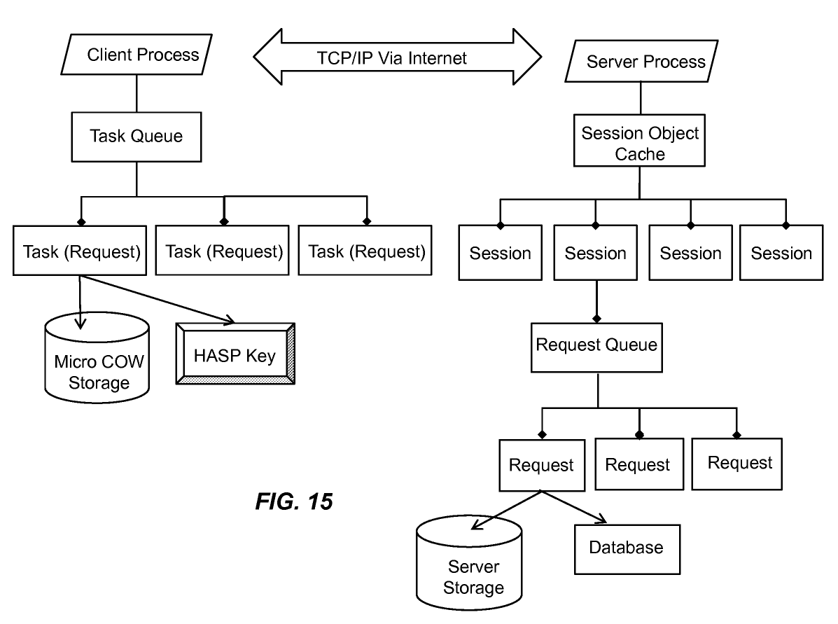

The following section outlines a process of updating the secure digital content stored on the flash memory storage medium 302, using an Internet connection to download updates. FIG. 15 provides an overview of the architecture and update processes described below.

The Update Process (hereafter referred to as the Update Process) has two distinct components: a server running at the secure digital content provider and a client running on the portable unit 10. In one embodiment, the server process may be available at all times. The client process may be invoked only when the portable unit 10 is not in use for classroom purposes (either by scheduling or by explicit invocation by the teacher or whomever is responsible for the portable unit 10).

The server's architecture includes a directory of secure digital content file structures, a database of information specific to portable unit 10 (e.g., unique identifiers for each unit 10, authorized content, and a user ID and password for the unit 10. Additional information may include a log of each update request and its status), and a process for handling requests from remote units 10.

The client's architecture requires access to disk storage 302 on portable unit 10, access to the HASP key 638, access to the Internet, and an update process that communicates with the server.

In one embodiment, Ruby may be used as the language for implementing the client. Ruby's library includes tools for communicating across the Internet and transferring files across the Internet. Ruby can run from an installation within the unit 10 without installing it on the hard disk of user's computer 658. In one embodiment, Java or Ruby may be used on the server side. Java may be faster than Ruby at run-time. At all times, media content is stored and transferred in encrypted form.

The following section outlines an embodiment of an automatic update process on the client side. Assumptions are that a course's directory structure remains static and file modification date differences are a good indicator of whether a file has been updated.

If an Internet connection is available, a request to log into the update server is sent. The request may include a unique identifier corresponding to the unit 10, a user name, and a password. If the server responds with a successful login, a handle is provided which uniquely identifies this update session and that handle is implicitly provided in all subsequent requests to the server. If the server denies access, the top level process exits in failure.

After successfully logging into the server, a request is sent to the server requesting the modification time of the data files for the unit 10. The modification times from the server are compared to the modification times of the files on the unit 10. If the modification time of a file has changed, a download request for the file is added to the task queue. If the request failed, the process exits.

For each file, the modification time on the server is compared to the modification time on the unit 10. If the modification time on the server is more recent than that on the unit 10, an update files request is added to the task queue for the course. If there are tasks in the task queue, a temporary directory is created to store any files that will be downloaded. While requests remain in the task queue, the request is processed. A logout request is sent to the server. If the update process has terminated in failure, the temporary directory along with any files in the directory is deleted. If the update process has not terminated in failure, contents of the temporary directory are copied to the unit 10's content directory; the temporary directory along with any files in the directory is then deleted.

The following section outlines the various request types from the portable unit 10. One type of request is a request for modification time of file. To process this request, a request is sent to the server for the modification time of a specific file. If the response is successful, the file modification time is returned. If the response is not successful, a failure to download request is added to the front of the task queue and a message indicating the cause of failure is associated with it.

Another type of request is a request to download a mapping file. To process this request, a request is sent to the server to download the mapping file and store it in the data directory of the temporary files directory (see above). If this download fails, a failure to download request is added to the front of the task queue and a message is associated with it indicating the cause of failure.

Another type of request is a request to download a content file. To process this request, a request is sent to the server to download the file and store it in the data directory of the temporary files directory (see above). If this file download fails, a failure to download request is added to the front of the task queue and a message indicating the cause of failure is associated with it. If the file is successfully downloaded, a modified list (see below) is created and a download request for each modified file is added to the task queue. Next, a new list (see below) is created and a download request is added for each new file to the task queue.

The following section outlines an embodiment of an automatic update process on the server side. Assumptions are that the server has access to a directory containing the encrypted data and/or media files of the secured content to be downloaded.

When a login request arrives, it should include a unique identifier for the unit 10 as well as a user name and a password.

The server validates the login request. If the request is valid, then the server generates a session object, obtains that session object's session id, and replies to the login request with that session id. Additionally, the server logs the successful request. If the request is not valid or if the server cannot schedule the update, for any reason, it logs its failure to permit access and it sends a request denied response to the client.

When a session request arrives, it is mapped to the session object corresponding to the session id. If no session object matches the id, an access denied message is returned to the client.

Each session object has an associated process which handles session requests. Requests of a specific session are enqueued in a session's request queue. The session request remains alive until either it executes a logout request, it times out, or it is killed by the top level process.

The session object process first includes subprocess 1, where a timer object is created and scheduled to interrupt the process when the timeout interval passes. If the timer object is not destroyed before it interrupts the process, upon interrupt the session process ends and the session object is disposed of.

The session object process next includes subprocess 2, where if a request arrives, it is enqueued in the session's request queue. The following are done until killed: while the session's request queue is empty, sleep for a short interval; while the session's request queue is not empty: kill the timer object process; dequeue a request and process the request; create a new timer object process; and log the request and its status (success or failure).

The following section outlines the various server side request types. One type of request is a request for modification time of file. This request is processed by: attempting to find the file on the server; if the file is not present, respond with failure; if the file is present, obtain its modification time and respond with this time.

Another type of request is a request to download a mapping file. This request is processed by: attempting to find the file on the server; if the file is not present, respond with failure; if the file is present, send the file as a response.

Another type of request is a request to download a content file. This request is processed by: attempting to find the file on the server; if the file is not present, respond with failure; if the file is present, send the file as a response.

Finally, another type of request is a logout request. This request is processed by: logging the logout request; removing the session object from the top level's cache of session objects; and deleting the session object.

In summary, there is provided a secure digital content delivery system. The disclosed system includes a storage medium 302 with secure digital content along with an embedded computing device 304 for making the secure digital content available via a computing device interface 306.

The present invention has been described above with reference to a preferred embodiment. However, those skilled in the art will recognize that changes and modifications may be made in this preferred embodiment without departing from the scope of the present invention. The processing features and functions described herein can be implemented in various manners. The foregoing description of the preferred embodiments, therefore, is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A secure digital content delivery system, comprising:
a portable unit, said portable unit comprising:
a computing device, said computing device comprising:
a hardware encryption key; and
a hardware encryption key storage medium, said hardware encryption key storage medium comprising:
a hardware encryption key application program interface; and
a hardware encryption key licensing component;
a storage medium, said storage medium comprising:
a secure digital content application, said secure digital content application comprising a licensing component;
a software program for converting said secure digital content application to a Microsoft Windows application;
a dynamic link library, said dynamic link library serving as a bridge between said hardware encryption key application program interface and said software program by passing all arguments by value and maintaining all handles required by the hardware encryption key application program interface; and
a computing device interface, said computing device interface for making said secure digital content application available on a computer.

2. The secure digital content delivery system of claim 1, wherein said storage medium comprises a flash memory storage medium.

3. The secure digital content delivery system of claim 1, wherein said computing device is a 128 bit AES encryption computing device.

4. The secure digital content delivery system of claim 1, wherein said computing device interface is a USB interface.

5. The secure digital content delivery system of claim 1, wherein said secure digital content application comprises an Adobe Flash application.

6. The secure digital content delivery system of claim 5, wherein said software program for converting said secure digital content application to a Microsoft Windows application comprises Zinc.

7. The secure digital content delivery system of claim 1, wherein said secure digital content application comprises an ActionScript application.

8. The secure digital content delivery system of claim 7, wherein said software program for converting said secure digital content application to a Microsoft Windows application comprises Zinc.

9. The secure digital content delivery system of claim 1, wherein said dynamic link library comprises a Visual C++ dynamic link library.

10. The secure digital content delivery system of claim 1, wherein said licensing component comprises a set of Adobe Flash classes.

11. The secure digital content delivery system of claim 10, wherein said Adobe Flash classes are written in a combination of ActionScript and Zinc's MDM Script.

12. A secure digital content delivery method, comprising:
connecting a portable unit to a computer, said portable unit comprising:
a computing device, said computing device comprising:
a hardware encryption key; and
a hardware encryption key storage medium, said hardware encryption key storage medium comprising:
a hardware encryption key application program interface; and
a hardware encryption key licensing component;
a storage medium, said storage medium comprising:
a secure digital content application, said secure digital content application comprising a licensing component;
a software program for converting said secure digital content application to a Microsoft Windows application;
a dynamic link library, said dynamic link library serving as a bridge between said hardware encryption key application program interface and said software program by passing all arguments by value and maintaining all handles required by the hardware encryption key application program interface; and
a computing device interface, said computing device interface for making said secure digital content application available on said computer.

13. A secure digital content delivery system, comprising:
a peripheral device;
a portable unit embedded in said peripheral device, said portable unit comprising:
a 128 bit AES encryption computing device, said 128 bit AES encryption computing device comprising:
a hardware encryption key; and
a hardware encryption key storage medium, said hardware encryption key storage medium comprising:
a hardware encryption key application program interface; and
a hardware encryption key licensing component;
a flash memory storage medium, said flash memory storage medium comprising:
an Adobe Flash application, said Adobe Flash application comprising a set of Adobe Flash classes, said Adobe Flash classes written in a combination of ActionScript and Zinc's MDM Script;
a Zinc software program for converting said Adobe Flash application to a Microsoft Windows application;
a Visual C++ dynamic link library, said Visual C++ dynamic link library serving as a bridge between said hardware encryption key application program interface and said Zinc software program by passing all arguments by value and maintaining all handles required by the hardware encryption key application program interface; and
a USB interface, said USB interface for making said secure digital content application available on said peripheral device.

14. The secure digital content delivery system of claim 13, wherein said peripheral device comprises an interactive whiteboard.

15. The secure digital content delivery system of claim 13, wherein said peripheral device comprises a printer audience response system.
